(19) United States
(12) Patent Application Publication
(10) Pub. No.: US 2024/0208069 A1
(43) Pub. Date: Jun. 27, 2024

(54) AUTOMATIC PICK AND PLACE SYSTEM

(71) Applicant: Siemens Aktiengesellschaft, Munich (DE)

(72) Inventors: Juan L. Aparicio Ojea, Moraga, CA (US); Heiko Claussen, Wayland, MA (US); Ines Ugalde Diaz, Redwood City, CA (US); Gokul Narayanan Sathya Narayanan, Emeryville, CA (US); Eugen Solowjow, Berkeley, CA (US); Chengtao Wen, Redwood City, CA (US); Wei Xi Xia, Daly City, CA (US); Yash Shahapurkar, Berkeley, CA (US); Shashank Tamaskar, Mohali, Punjab (IN)

(73) Assignee: Siemens Aktiengesellschaft, Munich (DE)

(21) Appl. No.: 18/555,758

(22) PCT Filed: May 25, 2021
(86) PCT No.: PCT/US2021/034013

§ 371 Date: Oct. 17, 2023

(51) Int. Cl. B25J 9/16

(52) U.S. Cl. CPC B25J 9/1697; B25J 9/1605

(57) ABSTRACT

Fully flexible kitting processes can be automated by generating pick and place motions for multi-robot, multi-gripper, robotic systems.

### BACKGROUND

Artificial Intelligence (AI) and robotics are a powerful combination for automating tasks inside and outside of the factory setting. Autonomous operations in dynamic environments may be applied to mass customization (e.g., high-mix, low-volume manufacturing), on-demand flexible manufacturing processes in smart factories, warehouse automation in smart stores, automated deliveries from distribution centers in smart logistics, and the like. In order to perform autonomous operations, such as pick and place operations, robots may use design information associated with a product. In some cases, robots are used to assemble or pack a kit (e.g., blister packs or blisters) of products or items (e.g., cartridges, razor handles, creams, soaps, etc.) based on a digital twin of the product. Such kits can change frequently, for instance when packaging changes or objects for the kits are added to the kit or dropped from the kit. High variability of kits and in the formats of how objects are presented, among other issues, present problems in automating many assembly tasks. Therefore, assembly tasks in current production facilities are often performed by humans.

### BRIEF SUMMARY

Embodiments of the invention address and overcome one or more of the described-herein shortcomings or technical problems by providing methods, systems, and apparatuses for robotic kitting. In particular, in accordance with various embodiments, fully flexible kitting processes can be automated by generating pick and place motions for multi-robot, multi-gripper, robotic systems.

In an example aspect, kitting operations are performed by an autonomous system that includes a computing system. An image of an object within a robotic cell can be captured, for instance by a sensor or camera. The object can be positioned in a first pose within the robotic cell. The computing system can receive or otherwise obtain robot configuration data associated with the robotic cell. The computing system can also receive or otherwise obtain one or more models associated with the object and a container. Based on the image of the object, the computing system can determine a first estimation of the first pose of the object. Based on the one or more models, the computing system can determine a second estimation of a second pose of the object. The second pose can represent a destination pose of the object in the container. Based on the robot configuration data, the first estimation of the first pose, and the second estimation of the second pose, the computing system can determine a sequence for performing the kitting operation. In some examples, the computing system selects at least one robot within the robotic cell to perform at least a portion of the sequence. The computing system can generate an instruction for the at least one robot to perform the portion of the sequence. In some cases, based on the instruction, the one or more robots perform the sequence so as to complete the kitting operation.

### BRIEF DESCRIPTION OF THE SEVERAL VIEWS OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 shows an example system that includes an autonomous machine in an example robotic cell that includes various objects, in accordance with an example embodiment.

FIG. 2 illustrates an example computing system configured to plan kitting operations, in accordance with an example embodiment.

FIG. 3 is a flow diagram that illustrates example kitting operations that can be performed by an autonomous system having the computing system, in accordance with an example embodiment.

FIG. 4 illustrates a computing environment within which embodiments of the disclosure may be implemented.

### DETAILED DESCRIPTION

As an initial matter, it is recognized herein that appropriate hardware is often needed for robotic kitting. Kitting generally refers to operations involved in picking and placing or inserting objects in a container or kit. In some cases, for example, robots having a wide reach and/or multiple gripping modalities are used in kitting operations. It is further recognized herein that there is a wide range of robots that perform automated tasks in manufacturing. Such robots can include various robotic arms that define various degrees of freedom, reach, sizes, and the like. Furthermore, the robotic arm can define various end effectors, such as grippers with parallel jaws or suction cups. Although specific robotic arms or end effectors may be discussed herein for purposes of example, it is appreciated that robots define various arms and end effectors, and all such robots are contemplated as being within the scope of this disclosure.

In some cases, robots can rely on software to perform its operations. Such software can include trajectory planners and simulations tools for robotic arms, control software to command robotic motion, and the like. Some robots can use machine vison for pose estimation of objects. It is recognized herein that such software and hardware is typically not connected for robotic systems that include autonomous machines to perform fully flexible automated kitting. Embodiments described herein can estimate the pose of various target objects and destination blister packs (or blisters). Based on the estimations, robotic motions can be determined that can enable various robots and grippers in various positions to efficiently and successfully perform various kitting operations. For example, various robots can be instructed to perform pick and place operations in accordance with the determined motions. As used herein, blisters, blister packs, kits, containers, and the like can be used interchangeably without limitation, unless otherwise specified.

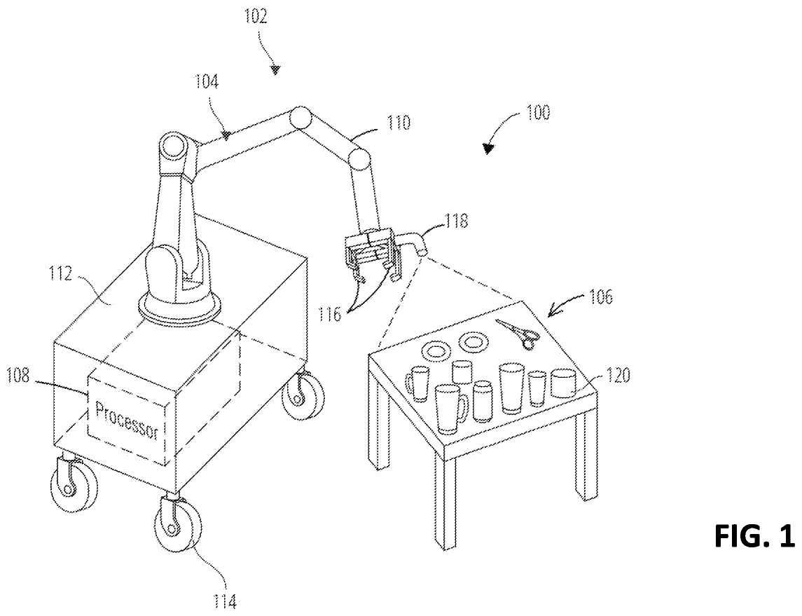

Referring now to FIG. 1, an example industrial or physical environment 100 is shown. As used herein, a physical environment can refer to any unknown or dynamic industrial environment. A reconstruction or model may define a virtual representation of the physical environment 100 or one or more objects 106 within the physical environment 100. The physical environment 100 can include a computerized autonomous system 102 configured to perform one or more manufacturing operations, such as assembly, transport, or the like. The robotic autonomous system 102 can include one or more robot devices or autonomous machines, for instance an autonomous machine or robot 104, configured to perform one or more industrial tasks, such as bin picking, grasping, placing, kitting, or the like. The system 102 can include one or more computing processors configured to process information and control operations of the system 102, in particular the robot 104. The robot 104 can include one or more processors, for instance a processor 108, configured to process information and/or control various operations associated with the autonomous machine 104. An autonomous system for operating an autonomous machine within a physical environment can further include a memory for storing modules. The processors can further be configured to execute the modules so as to process information and generate models based on the information. It will be understood that the illustrated environment 100 and the system 102 are simplified for purposes of example. The environment 100 and the system 102 may vary as desired, and all such systems and environments are contemplated as being within the scope of this disclosure.

Still referring to FIG. 1, the robot 104 can further include a robotic arm or manipulator 110 and a base 112 configured to support the robotic manipulator 110. The base 112 can include wheels 114 or can otherwise be configured to move within the physical environment 100. The autonomous machine 104 can further include an end effector 116 attached to the robotic manipulator 110. The end effector 116 can include one or more tools configured to grasp and/or move objects 106. Example end effectors 116 include finger grippers or vacuum-based grippers. The robotic manipulator 110 can be configured to move so as to change the position of the end effector 116, for example, so as to place or move objects 106 within the physical environment 100. The system 102 can further include one or more cameras or sensors, for instance a three-dimensional (3D) point cloud camera 118, configured to detect or record objects 106 within the physical environment 100. The camera 118 can be mounted to the robotic manipulator 110 or otherwise configured to generate a 3D point cloud of a given scene, for instance the physical environment 100. Alternatively, or additionally, the one or more cameras of the system 102 can include one or more standard two-dimensional (2D) cameras that can record or capture images (e.g., RGB images or depth images) from different viewpoints. Those images can be used to construct 3D images. For example, a 2D camera can be mounted to the robotic manipulator 110 so as to capture images from perspectives along a given trajectory defined by the manipulator 110.

With continuing reference to FIG. 1, in an example, one or more cameras can be positioned over the autonomous machine 104, or can otherwise be disposed so as to continuously monitor any objects within the environment 100. For example, when an object, for instance one of the objects 106, is disposed or moved within the environment 100, the camera 118 can detect the object. In an example, the processor 108 can determine whether a given object that is detected is recognized by the autonomous system 102, so as to determine whether an object is classified as known or unknown (new).

As described above, it is recognized herein that complex assemblies of kits, which can be referred to as kitting, are typically performed by human operations due to the high variability of kits and objects, and due to the frequency at which new kits and objects are introduced, among other reasons. It is further recognized herein that there can be technical challenges associated with determining and programming robotic motions for a single kit or multiple kits. For example, in some cases, programming a robot for a single kit may require that objects are presented in fixtures in which the robot can reach in a single motion, but objects are often delivered in boxes in which the objects can fall in random positions. Even when proper fixtures are prepared, programming efficient robot motions can require much time, skill, and iterations using current approaches.

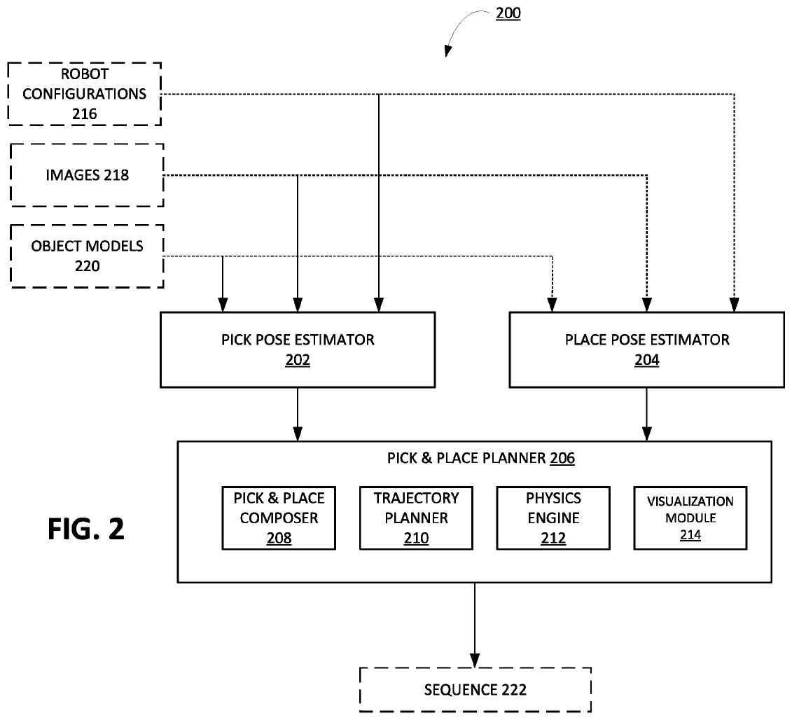

Referring now to FIG. 2, in accordance with various embodiments, a computing system 200 can be configured to determine pick and place operations, so as to define fully flexible kitting in various manufacturing or industrial applications. The computing system 200 can include one or more processors and memory having stored thereon applications, agents, and computer program modules including, for example, a pick pose estimator 202, a place pose estimator 204, and a pick and place planner 206. The pick and place planner 206 can define, and thus the computing system 200 can further include, a pick and place composer 208, a trajectory planner 210, a physics engine 212, and a 3D visualization module 214. It will be appreciated that the program modules, applications, computer-executable instructions, code, or the like depicted in FIG. 2 are merely illustrative and not exhaustive, and that processing described as being supported by any particular module may alternatively be distributed across multiple modules or performed by a different module. In addition, various program module(s), script(s), plug-in(s), Application Programming Interface(s) (API(s)), or any other suitable computer-executable code may be provided to support functionality provided by the program modules, applications, or computer-executable code depicted in FIG. 2 and/or additional or alternate functionality. Further, functionality may be modularized differently such that processing described as being supported collectively by the collection of program modules depicted in FIG. 2 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 2 may be implemented, at least partially, in hardware and/or firmware across any number of devices.

With continuing reference to FIG. 2, the computing system 200 can store, or can otherwise obtain, various data that the computing system 200 can use to compose pick and place operations for kitting. For example, the computing system 200 can be communicatively coupled to a database that stores data for composing pick and place operations for kitting. Additionally, or alternatively, the computing system 200 can define one or more robotic cells from which data is obtained. A robotic cell can refer to the physical environment or system in which one or more robots operate. By way of example, the autonomous system 102 can define a robotic cell that is communicatively coupled to, or is part of, the computing system 200. The data can include, for example, robot configuration data 216, images or view data 218, and object models 220.

The robot configuration data 216 can identify particular robots that are available in a particular robotic cell or autonomous system. The robot configuration data 216 can further indicate grasping modalities (e.g., suction, pinch) associated with robots that are available in a particular cell or system. Further still, the robot configuration data 216 can indicate various specifications associated with respective robots, such as sizes related to grasping, distances related to trajectories that robots can travel (which can be referred to as the robot workspace), or the like. Additionally, or alternatively, the robot configuration data 216 can include the position of the robots within the robotic cell, payloads of the robots (e.g., maximum weight that a robot can carry), and an indication of the types of grippers or tool changers that a given robot can carry. The robot configuration data 216 can also include various models associated with the robots within a given robotic cell. Such models can include, for example and without limitation, collision models of a robot or kinematics models of a robot. By way of example, collision models can define a CAD model of a robotic arm, for instance the manipulator 110, which can be used to determine if the robot collides with other objects or equipment within the robotic cell. Kinematics models can be used to translate robot poses from joint space to cartesian space, and visa-versa.

The images 218 can include current views of respective scenes or physical environments that are captured by various vision systems that include one or more cameras or sensors, such as the camera 118. Vision systems that capture the images 218 can further include three-dimensional (3D) point cloud cameras or standard two-dimensional (2D) cameras that capture images (e.g., RGB images or depth images) from different viewpoints. Thus, the images 218 can define 3D images, 2D images, RGB depth images, or the like. The object models 220 can include 3D models, such as computer-aided design (CAD) models of objects associated with kitting. For example, the object models 220 can include models of a kit, models of objects destined for a kit, or objects of models in a kit.

With continuing reference to FIG. 2, a given robotic cell or autonomous system can be equipped with a variety of robotic arms and gripers. Information associated with such robotic arms and grippers can be included in robot configurations data 216. The robot configurations data 216 can be sent to the pick pose estimator 202 and the place pose estimator 204, for example, when a kitting operation is triggered. In some cases, the robot configuration data 216 and the object models 220 are stored in a database that is accessible by the pick pose estimator 202 and the place pose estimator 204. For example, the final kit configuration can be determined from the object models 220. In particular, by way of example, when assembling a blister of various razor blades, the system 200 may obtain a CAD model or other 3D representation of the blades and the blister that includes markers. The markers can indicate the positions in which respective blades should be inserted in the blister. Such a model that includes markers can be referred to as the place model. Similarly, a model of the object that is being transported can be referred to as the pick model. Continuing with the razor blade example, when a kitting operation is triggered, the camera or cameras can take pictures (or point clouds) of the current scene, which can include the razor blades and blister (objects) that may be placed randomly in the robotic cell. The pictures of the scene (e.g., images 218) can then be transferred to both the pick pose estimator 202 and the place pose estimator 204. In some cases, both the estimators 202 and 204 can generate estimates of the poses of the objects that appear in the pictures. In particular, for example, the pick pose estimator 202 can determine estimates of the poses of the razor blades (or the pick objects) by matching the model of a given blade to the data in the pictures or points clouds representing the current scene. Thus, the pick pose estimator 202 can determine one or more estimations of feasible picks for the target object in its initial position. Similarly, the place pose estimator 204 can determine an estimate of the pose of the razor blades (or the place objects) after insertion in the blister by matching the model of the blister to the data in the pictures or point clouds representing the current scene.

Thus, images 218 can be sent to the pick pose estimator 202 and the place pose estimator 204, for example, when a kitting operation is triggered. In some cases, cameras capture the images 218 of the scene in which the cameras are positioned. Various objects that are being kitted can be present in the scene, such that the images 218 include images of the objects that are being kitted. In some examples, the objects can be positioned within the robotic cell arbitrarily but within view of at least one camera or sensor and within reach of the robots associated with the robot configuration data 216. Based on the objects represented by the images 218, the object models 220 that represent the objects can be retrieved by the pick pose estimator 202 and the place pose estimator 204. In some cases, the object models 220 depict the objects in the kit that is being used in the kitting operation. Further, in some examples, the object models 202 can define markers that indicate respective destination poses. A destination pose can refer to a position of an object after it is inserted in a particular kit or blister. Thus, the destination pose of an object can vary based on the kit to which it is destined (or destination).

The pose estimators 202 and 204 can use the object models 220 to determine what the target objects looks like before finding them in a current scene defined by the images 218. The object models 220 can define CAD models or other 3D representations. In some cases, the format of the object models 200 can vary based on pose matching algorithms that the estimators 202 and 204 implement. In some examples, markers in 3D representations of industrial kits can be annotated within a given 3D representation or CAD model. Markers can indicate various positions within the blister where objects should be inserted. For example, a marker can be in the format of a 6 degree of freedom (6 DoF) pose (e.g., X, Y, Z, roll, pitch, yaw) of the pick object with respect to a reference frame defined by the blister, though it will be understood that the format of markers can vary as desired, and all such formats are contemplated as being within the scope of this disclosure.

In an example, based on a current view of the scene defined by the images 218, available grasping modalities defined by the robot configuration data 216, and a target 3D model defined by the object models 220, the pick pose estimator 202 can compute feasible picks for the target object. The available grasping modalities can include data or parameters related to grasps, such as the width that a parallel jaw can extend, the size of a suction cup, the material of an end effector, or the like. The target 3D model can include a target object, for instance a target object 120 of the objects 106 (see FIG. 1), which can refer to a particular object that is being picked (grasped) and placed into a kit or container. It will be understood that the target object 120 is referenced for purposes of example, but target objects can define any alternative shapes or sizes, and all such target objects are contemplated as being within the scope of this disclosure. In particular, the pick pose estimator 202 can detect the target object 120 in the view of the scene from the images 218. Based on the detection, the pick pose estimator 202 can determine or estimate the current pose or position of the target object 120 within the physical environment. The pick pose estimator 202 can identify the target object 120 from the images 218. Based on identifying the target object 120, the pick place estimator 202 can retrieve the object model 220 that represents the target object 120 in the kit, or in its target pose.

The target pose, or final pose of the target object, can be determined by the position of the blister. For example, the place pose estimator 204 can determine estimates of the position of the blister, and thus also the desired position of the target object within the blister. In particular, for example, the desired position of the target object can be extracted from an object model of the blister. Further, the object model of the blister can include markers that define the position of the target objects in their respective final destination pose or inserted pose within the blister.

Based on the available grasping modalities and the current pose that is determined or estimated, the pick pose estimator 202 can select a particular grasping modality, and thus robot, for performing the pick operation. In some cases, the pick pose estimator 202 can determine a plurality of feasible picks. The plurality of feasible picks can each define a pose of the end-effector for grasping (or grasp pose), the associated grasp modality, and a grasp quality. The grasp quality can refer to a metric that indicates a priori robustness of the estimated grasp, which may vary based on the pose estimation and the grasp modality. By way of example, a bottle that lies flat on a surface may be grasped with a suction gripper having a certain diameter at certain coordinates of the bottle with 87% grasp quality, whereas the same bottle might be grasped with the same suction gripper at different coordinates (e.g., near an edge of the bottle) with 40% grasp quality.

Continuing to refer to FIG. 2, based on the current view of the scene defined by the images 218, available grasping modalities defined by the robot configuration data 216, and a target 3D model defined by the object models 220, the place pose estimator 204 can compute feasible insertions for a given target object, for instance the target object 120. In particular, the object models 220 can include a model of the target blister or container, and thus the computed insertions can define a target pose for the target object to be placed within the target blister or container, from the current pose of the target object. The place pose estimator 204 can use a model of the blister and images 118 of the scene to determine an exact pose of the blister within the robotic cell. As described above, the model of the blister can include markers that identify final poses of objects within the blister, such that after the pose of the blister is estimated, the final pose of the target object is also determined.

In various examples, the target blister can hold more than one object. Thus, in some cases, the target object model associated with the target blister can indicate which of the plurality of object poses should be computed by the place pose estimator 204. Based on current view of the scene defined by the images 218, the place pose estimator 204 can detect the target blister, and compute or estimate insertion poses for one or more target objects in the target blister. Further, for example, based on the robot configuration data 216, target object models, and associated insertion poses that are estimated, the place pose estimator 206 can evaluate different grasping modalities so as to determine clearances associated with different grasping modalities. The clearances may refer to distances between the target object and the target blister as the robot grasps or inserts the target object in the computed insertion pose at or near the insertion location. By way of example, a clearance that is greater than a predetermined threshold may allow a parallel jaw finger gripper to insert the target object, whereas a clearance that is less than the predetermined threshold may require a suction cup gripper to insert the same target object. Thus, the place pose estimation can compute or estimate insertions, and such insertions may include a pose of the end effector at insertion, the associated grasp modality, and an insertion quality, which can be similar to the grasp quality described above.

The pick pose estimator 202 and the place pose estimator 204 may operate in parallel. Thus, feasible picks and feasible insertions can be computed by, respectively, the pick pose estimator 202 and the place pose estimator 204 in parallel for a given target object and target blister. After the feasible picks and feasible insertions are computed, the feasible picks and feasible insertions can be sent to the pick and place planner 206. The pick and place planner 206 can also receive the robot configuration data 216, which can indicate available robot types, available grippers, and the positions of each robot in a cell. Based on the robot configuration data 216 and the feasible picks and insertions, the pick and place planner 206 can determine and output a pick and place motion sequence 222. In some cases, the pick and place planner 206 can send the sequence 222 to the associated robotic cell in the form of an instruction, so that the selected robot performs the kitting operation in accordance with the sequence 222.

By way of a specific example, and without limitation, the pick pose estimator 202 can generate a plurality of feasible picks for a given target object, for instance a first feasible pick, a second feasible pick, and a third feasible pick. The feasible picks can rely on the same gripper (e.g., a suction gripper) and can be sorted based on grasp quality. The place pose estimator 204 can generate a single target pose (or place) because the example insertion pose is precise and defines specific degrees of freedom for successfully inserting the target object. Continuing with the example, the pick and place planner 206 can derive a motion sequence 222 that connects any of the first, second, and third feasible picks to the target pose. In particular, the pick and place composer 208 can match each pick to a place. In the example, the pick and place composer 208 can match the first feasible pick to the target place, the second feasible pick to the target place, and the third feasible pick to the target place. In another example having different feasible picks and places, the pick and place composer 208 might discard combinations of picks and places. For example, a given pick and place might be defined as low quality by the pick and place composer 208 because it requires a handover to a second or third robot that is not required by other combinations. A pick and place involving a handover might reduce quality and increase cycle time as compared to other pick and places of the same target object that do not require a handover. After the pick and place composer 208 determines or computes the pick and place combinations, the physics engine 212 and the trajectory planner 210 can perform simulations with the combinations to determine best performing combination. In various examples, the best combination is the one that is simulated to be the fastest and most reliable.

In particular, for example, a simulation can perform a robot trajectory that effectively connects the pick and place poses by way of robot grasp-motion-release. The optimized trajectory can be planned by the trajectory planner 210 while the physics engine 212 can verify that the grip on the target object is firm such that the object does not fall from the robot gripper, and such that the object can inserted without damages to the blister. In some examples, after the simulations are performed to select the best combination, the pick and place planner 206 outputs the best combination in the form of the selected motion sequence 222.

Thus, the sequence 222 can connect one of the feasible picks from the pick pose estimator 202, with one of the feasible insertions from the place pose estimator 204. In some cases, the pick and place planner 260 can prioritize the feasible picks and the feasible insertions based on their grasp qualities and insertion qualities, respectively. In particular, based on respective grasping modalities associated with each of the feasible picks and feasible insertions, the pick and place composer 208 can determine which of the available robots can perform each of the actions (e.g., pick and place or insertion) associated with kitting the target object in the target container. By way of example, if the pick and place composer 208 determines that none of the feasible picks and feasible insertions can be performed or connected by a single robot, the pick and place composer 208 may select one or more additional robots for performing at least one of the maneuvers involved in the kitting operation. By way of further example, the pick and place composer 202 can select a first robot for performing a pick operation on a target object, and a second robot for perform a place operation on the target object. Thus, in response to the sequence 222, the first robot can perform the pick on the target object, then hand over the target object to the second robot, which can perform the place operation. In some cases, the pick and place composer 208 can define a handover between two or more robots in the sequence 220 to combine different grasping modalities, or to change or correct the pose of the target object before the target object is inserted in the container in its target pose.

The trajectory planner 210 can compute paths associated with moving the target object from its current pose to its target pose in the target container. The trajectory planner 210 can compute such paths such that the robots and the target object do not collide with other objects. In some examples, the physics engine 212 evaluates the various grasps, handovers, and insertions to determine respective predicted success rates. The visualization module 214 may generate 3D models of the sequence 222, so as to provide feedback to human operators supervising the related robotic cell. In some cases, the visualization module 214 can display the final selected sequence 222 prior to its execution, so that a human can validate or verify the selected pick and place operation.

Without being bound by theory, in accordance with various embodiments, the pick and place planner 206 can converge the outputs of the pick pose estimator 202 and the place pose estimator 204, so as to connect a feasible pick with a feasible insertion in the most efficient manner, thereby enabling fully automated and flexible kitting operations. In some cases, based on 3D models of objects and a given blister, the system 102 can automatically adapt to a new kit and perform the assembly of the new kit. Further, the computing system 200 can evaluate multiple robots and multiple gripper configurations, such that the system 200 can make selections from a plurality of grippers and robots. In some cases, the system 200 can select more than one gripper or a robot for a given kitting operation, such that robot-to-robot handovers are performed.

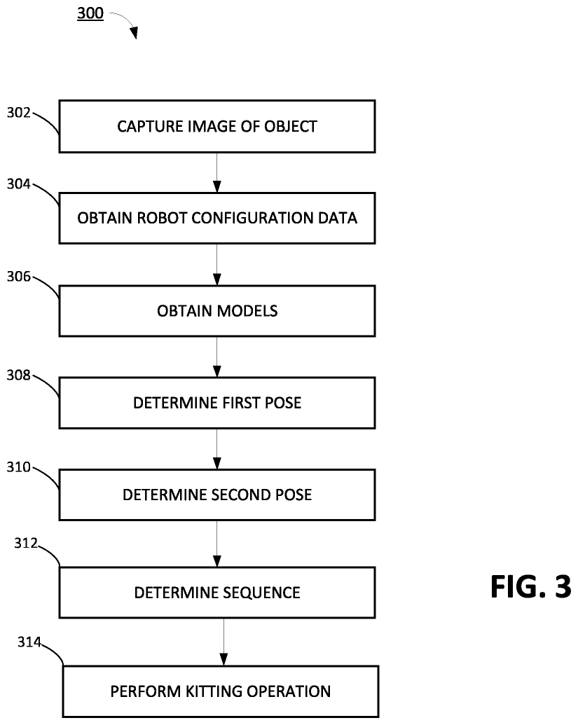

Referring now to FIG. 3, example kitting operations 300 can be performed by an autonomous system that includes the computing system 200, for instance the autonomous system 102. At 302, an image of an object within a robotic cell can be captured, for instance by the sensor or camera 118. The object can be positioned in a first pose within the robotic cell. At 304, the computing system 200 can receive or otherwise obtain robot configuration data associated with the robotic cell. At 306, the computing system can receive or otherwise obtain one or more models associated with the object and a container. At 308, based on the image of the object, the computing system 200 can determine a first estimation of the first pose of the object. At 310, based on the one or more models, the computing system 200 can determine a second estimation of a second pose of the object. The second pose can represent a destination pose of the object in the container. At 312, based on the robot configuration data, the first estimation of the first pose, and the second estimation of the second pose, the computing system 200 can determine a sequence for performing the kitting operation. In some examples, the computing system 200 selects at least one robot within the robotic cell to perform at least a portion of the sequence. The computing system 200 can generate an instruction for the at least one robot to perform the portion of the sequence. At 314, in some cases, based on the instruction, the robot performs the sequence or the portion of the sequence so as to complete the kitting operation.

For example, the robot configuration data can indicate respective grasping modality information associated with each robot within the robotic cell. In some cases, based on the grasping modality information, the computing device 200 can select a first robot for picking the object from the first pose, and select a second robot for placing the object in the container in the destination pose. Thus, in some examples, at 314, the first robot can pick up the object from the first pose, the first robot can transfer the object to the second robot so as to complete a handover operation, and the second robot can place the object within the container in the destination pose in accordance with the sequence so as to complete the kitting operation. In another example, determining the sequence further includes determining that a plurality of robots within the robotic cell are capable of performing the kitting operation. The computing system 200 can determine a respective grasp accuracy for each robot of the plurality of robots. The grasp accuracy can be associated with picking the object from the first pose. The computing system 200 can further determine a respective insertion accuracy for each robot of the plurality of robots. The insertion accuracy can be associated with placing the object in the destination pose within the container. Continuing with the example, based on the grasp accuracies and the insertion accuracies, the computing system 200 can select one robot of the plurality of robots for performing the kitting operation in accordance with the sequence.

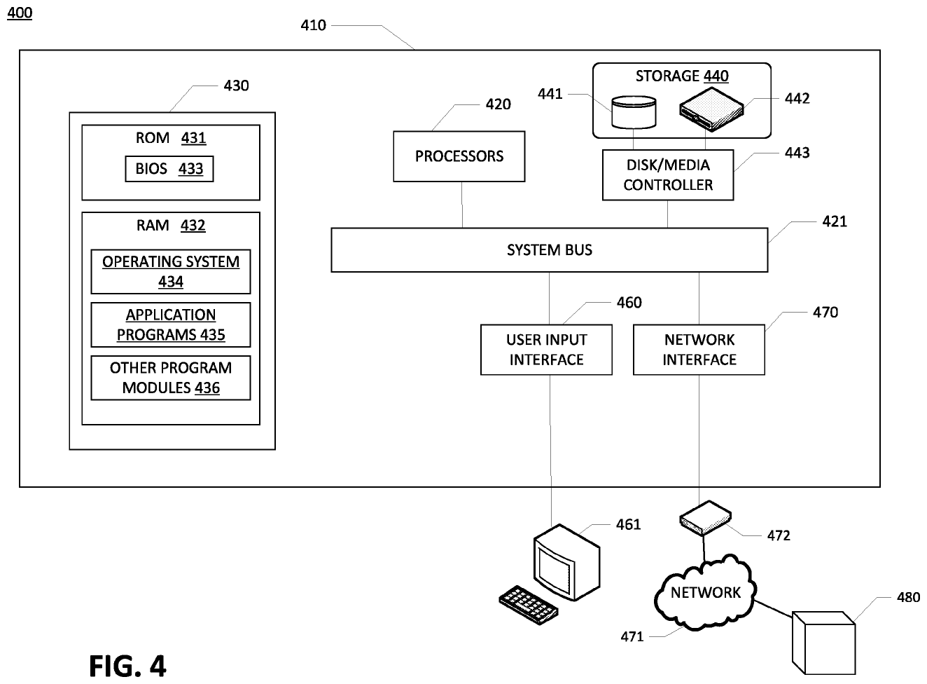

FIG. 4 illustrates an example of a computing environment within which embodiments of the present disclosure may be implemented. A computing environment 400 includes a computer system 410 that may include a communication mechanism such as a system bus 421 or other communication mechanism for communicating information within the computer system 410. The computer system 410 further includes one or more processors 420 coupled with the system bus 421 for processing the information. The autonomous system 102 and the computing system 200 may include, or be coupled to, the one or more processors 420.

The processors 420 may include one or more central processing units (CPUs), graphical processing units (GPUs), or any other processor known in the art. More generally, a processor as described herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general-purpose computer. A processor may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 420 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor may be capable of supporting any of a variety of instruction sets. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

The system bus 421 may include at least one of a system bus, a memory bus, an address bus, or a message bus, and may permit exchange of information (e.g., data (including computer-executable code), signaling, etc.) between various components of the computer system 410. The system bus 421 may include, without limitation, a memory bus or a memory controller, a peripheral bus, an accelerated graphics port, and so forth. The system bus 421 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

Continuing with reference to FIG. 4, the computer system 410 may also include a system memory 430 coupled to the system bus 421 for storing information and instructions to be executed by processors 420. The system memory 430 may include computer readable storage media in the form of volatile and/or nonvolatile memory, such as read only memory (ROM) 431 and/or random access memory (RAM) 432. The RAM 432 may include other dynamic storage device(s) (e.g., dynamic RAM, static RAM, and synchronous DRAM). The ROM 431 may include other static storage device(s) (e.g., programmable ROM, erasable PROM, and electrically erasable PROM). In addition, the system memory 430 may be used for storing temporary variables or other intermediate information during the execution of instructions by the processors 420. A basic input/output system 433 (BIOS) containing the basic routines that help to transfer information between elements within computer system 410, such as during start-up, may be stored in the ROM 431. RAM 432 may contain data and/or program modules that are immediately accessible to and/or presently being operated on by the processors 420. System memory 430 may additionally include, for example, operating system 434, application programs 435, and other program modules 436. Application programs 435 may also include a user portal for development of the application program, allowing input parameters to be entered and modified as necessary.

The operating system 434 may be loaded into the memory 430 and may provide an interface between other application software executing on the computer system 410 and hardware resources of the computer system 410. More specifically, the operating system 434 may include a set of computer-executable instructions for managing hardware resources of the computer system 410 and for providing common services to other application programs (e.g., managing memory allocation among various application programs). In certain example embodiments, the operating system 434 may control execution of one or more of the program modules depicted as being stored in the data storage 440. The operating system 434 may include any operating system now known or which may be developed in the future including, but not limited to, any server operating system, any mainframe operating system, or any other proprietary or non-proprietary operating system.

The computer system 410 may also include a disk/media controller 443 coupled to the system bus 421 to control one or more storage devices for storing information and instructions, such as a magnetic hard disk 441 and/or a removable media drive 442 (e.g., floppy disk drive, compact disc drive, tape drive, flash drive, and/or solid state drive). Storage devices 440 may be added to the computer system 410 using an appropriate device interface (e.g., a small computer system interface (SCSI), integrated device electronics (IDE), Universal Serial Bus (USB), or FireWire). Storage devices 441, 442 may be external to the computer system 410.

The computer system 410 may also include a field device interface 465 coupled to the system bus 421 to control a field device 466, such as a device used in a production line. The computer system 410 may include a user input interface or GUI 461, which may comprise one or more input devices, such as a keyboard, touchscreen, tablet and/or a pointing device, for interacting with a computer user and providing information to the processors 420.

The computer system 410 may perform a portion or all of the processing steps of embodiments of the invention in response to the processors 420 executing one or more sequences of one or more instructions contained in a memory, such as the system memory 430. Such instructions may be read into the system memory 430 from another computer readable medium of storage 440, such as the magnetic hard disk 441 or the removable media drive 442. The magnetic hard disk 441 (or solid state drive) and/or removable media drive 442 may contain one or more data stores and data files used by embodiments of the present disclosure. The data store 440 may include, but are not limited to, databases (e.g., relational, object-oriented, etc.), file systems, flat files, distributed data stores in which data is stored on more than one node of a computer network, peer-to-peer network data stores, or the like. The data stores may store various types of data such as, for example, skill data, sensor data, or any other data generated in accordance with the embodiments of the disclosure. Data store contents and data files may be encrypted to improve security. The processors 420 may also be employed in a multi-processing arrangement to execute the one or more sequences of instructions contained in system memory 430. In alternative embodiments, hard-wired circuitry may be used in place of or in combination with software instructions. Thus, embodiments are not limited to any specific combination of hardware circuitry and software.

As stated above, the computer system 410 may include at least one computer readable medium or memory for holding instructions programmed according to embodiments of the invention and for containing data structures, tables, records, or other data described herein. The term “computer readable medium” as used herein refers to any medium that participates in providing instructions to the processors 420 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 441 or removable media drive 442. Non-limiting examples of volatile media include dynamic memory, such as system memory 430. Non-limiting examples of transmission media include coaxial cables, copper wire, and fiber optics, including the wires that make up the system bus 421. Transmission media may also take the form of acoustic or light waves, such as those generated during radio wave and infrared data communications.

Computer readable medium instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, may be implemented by computer readable medium instructions.

The computing environment 400 may further include the computer system 410 operating in a networked environment using logical connections to one or more remote computers, such as remote computing device 480. The network interface 470 may enable communication, for example, with other remote devices 480 or systems and/or the storage devices 441, 442 via the network 471. Remote computing device 480 may be a personal computer (laptop or desktop), a mobile device, a server, a router, a network PC, a peer device or other common network node, and typically includes many or all of the elements described above relative to computer system 410. When used in a networking environment, computer system 410 may include modem 472 for establishing communications over a network 471, such as the Internet. Modem 472 may be connected to system bus 421 via user network interface 470, or via another appropriate mechanism.

Network 471 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 410 and other computers (e.g., remote computing device 480). The network 471 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 471.

It should be appreciated that the program modules, applications, computer-executable instructions, code, or the like depicted in FIG. 4 as being stored in the system memory 430 are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the computer system 410, the remote device 480, and/or hosted on other computing device(s) accessible via one or more of the network(s) 471, may be provided to support functionality provided by the program modules, applications, or computer-executable code depicted in FIG. 4 and/or additional or alternate functionality. Further, functionality may be modularized differently such that processing described as being supported collectively by the collection of program modules depicted in FIG. 4 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 4 may be implemented, at least partially, in hardware and/or firmware across any number of devices.

It should further be appreciated that the computer system 410 may include alternate and/or additional hardware, software, or firmware components beyond those described or depicted without departing from the scope of the disclosure. More particularly, it should be appreciated that software, firmware, or hardware components depicted as forming part of the computer system 410 are merely illustrative and that some components may not be present or additional components may be provided in various embodiments. While various illustrative program modules have been depicted and described as software modules stored in system memory 430, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like can be additionally based on one or more other operations, elements, components, data, or the like. Accordingly, the phrase “based on,” or variants thereof, should be interpreted as “based at least in part on.”

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method of performing a kitting operation, the method comprising:
capturing an image of an object within a robotic cell, the object positioned in a first pose within the robotic cell;
based on the image, determining a first estimation of the first pose of the object;
receiving robot configuration data associated with the robotic cell;
receiving one or more models associated with the object and a container;
based on the one or more models, determining a second estimation of a second pose of the object, the second pose representative of a destination position of the object in the container; and
based on the robot configuration data, the first estimation of the first pose, and the second estimation of the second pose, determining a sequence for performing the kitting operation.

2. The method as recited in claim 1, wherein determining the sequence further comprises:
selecting at least one robot within the robotic cell to perform at least a portion of the sequence.

3. The method as recited in claim 2, the method further comprising:
generating an instruction for the at least one robot to perform the portion of the sequence; and
based on the instruction, the at least one robot performing the portion of the sequence so as to complete the kitting operation.

4. The method as recited in claim 2, wherein the robot configuration data indicates respective grasping modality information associated with each robot within the robotic cell, and determining the sequence further comprises:
based on the grasping modality information, selecting a first robot for picking the object from the first pose, and selecting a second robot for placing the object in the container in the destination pose.

5. The method as recited in claim 4, the method further comprising:
the first robot picking up the object from the first pose;
the first robot transferring the object to the second robot so as to complete a handover operation; and
the second robot placing the object within the container in the destination pose in accordance with the sequence so as to complete the kitting operation.

6. The method as recited in claim 1, wherein determining the sequence further comprises:
determining that a plurality of robots within the robotic cell are capable of performing the kitting operation;
determining a respective grasp accuracy for each robot of the plurality of robots, the grasp accuracy associated with picking the object from the first pose;
determining a respective insertion accuracy for each robot of the plurality of robots, the insertion accuracy associated with placing the object in the destination pose within the container; and
based on the grasp accuracies and the insertion accuracies, selecting one robot of the plurality of robots for performing the kitting operation in accordance with the sequence.

7. An autonomous system comprising:
a plurality of robots within a robotic cell, each robot defining an end effector configured to grasp an object within a physical environment;
a sensor configured to capture an image of an object within the robotic cell, the object positioned in a first pose,
one or more processors; and
a memory storing instructions that, when executed by the one or more processors, cause the autonomous system to:
based on the image, determine a first estimation of the first pose of the object;
receive robot configuration data associated with the robotic cell;
receive one or more models associated with the object and a container;
based on the one or more models, determine a second estimation of a second pose of the object, the second pose representative of a destination position of the object in the container; and
based on the robot configuration data, the first estimation of the first pose, and the second estimation of the second pose, determine a sequence for performing the kitting operation.

8. The autonomous system as recited in claim 1, the memory further storing instructions that, when executed by the one or more processors, further cause the autonomous system to:
select at least one robot of the plurality of robots within the robotic cell to perform at least a portion of the sequence.

9. The autonomous system as recited in claim 8, the memory further storing instructions that, when executed by the one or more processors, further cause the autonomous system to:
generate an instruction for the at least one robot to perform the portion of the sequence; and
send the instruction to the at least one robot.

10. The autonomous system as recited in claim 9, the at least one robot configured to, responsive to the instruction, perform the portion of the sequence so as to complete the kitting operation.

11. The autonomous system as recited in claim 8, wherein the robot configuration data indicates respective grasping modality information associated with each robot of the plurality of robots within the robotic cell, the memory further storing instructions that, when executed by the one or more processors, further cause the autonomous system to:
based on the grasping modality information, select a first robot of the plurality of robots for picking the object from the first pose, and select a second robot of the plurality of robots for placing the object within the container in the destination pose.

12. The autonomous system as recited in claim 11, wherein the first robot is configured to pick up the object from the first pose and transfer the object to the second robot so as to complete a handover operation.

13. The autonomous system as recited in claim 11, wherein the second robot is configured to place the object within the container in the destination pose in accordance with the sequence so as to complete the kitting operation.

14. The autonomous system as recited in claim 7, the memory further storing instructions that, when executed by the one or more processors, further cause the autonomous system to:
determine the plurality of robots within the robotic cell are capable of performing the kitting operation;
determine a respective grasp accuracy for each robot of the plurality of robots, the grasp accuracy associated with picking the object from the first pose;
determine a respective insertion accuracy for each robot of the plurality of robots, the insertion accuracy associated with placing the object in the destination pose within the container; and
based on the grasp accuracies and the insertion accuracies, select one robot of the plurality of robots for performing the kitting operation in accordance with the sequence.

15. A non-transitory computer-readable storage medium including instructions that, when processed by a computing system cause the computing system to perform the method according to claim 1.
